(19) United States
(12) Patent Application Publication
(10) Pub. No.: US 2007/0113169 A1
(43) Pub. Date: May 17, 2007

(54) Open law commentary on the internet

(76) Inventor: Norbert Gugerbauer, Wien (AT)

Correspondence Address: NORBERT GUGERBAUER, OPERNRING 1, WIEN, A - 1010, AT

(21) Appl. No.: 11/272,946

(22) Filed: Nov. 15, 2005

(51) Int. Cl. G06F 17/00

(52) U.S. Cl. 715/512; 715/530

(57) ABSTRACT

A method to comment statutes in the internet, comprising a database of comments to legal statutes which can be used online (through the World Wide Web) and which on the one hand consists of a version of—mostly voluminous—statutes partitioned into separate sections and paragraphs (e.g. the Uniform Commercial Code), on the other hand consists of a commentary (high-quality comments, especially regarding the case law and scholastic opinion) of the separate sections and paragraphs by continuously transmitted professional articles from voluntary users. Those articles are put in structure—i.e. put in order and provided with subheadings, but also deleted (if a wrong comment is obvious), by voluntary administrators.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Normally a professional legal writer analyzes court rulings or legal statutes and therefore uses all his skills and knowledge. Such a writer criticizes and pushes the legal development forward at the same time. Such a writer can exercise influence by his writing but also further his career and attract colleagues and future clients. The professional importance of such writing is determined by the way how easily an interested person can obtain that opinion and how many times the opinion is cited in other publications. Empirical studies about publications document that “open access” considerably increases the frequency of how often an opinion is read and cited. The work on traditional printed law commentaries is reserved to a small group of scholars. As a consequence, to the rather low demand for such (mostly expensive) books and the small number of legal publishers the number of both authors and commentaries remains low.

The potentialities (creativity, experience, knowledge) of individuals outside this group remain unused. Many judges make decisions which don't find their way to the public. Lawyers criticize predominant opinions in their often brilliant papers, which remain disclosed to the public, or they are published very late. Young lawyers discover new perspectives and often look for an appropriate forum to publish them—without success. This invention is a new way of publishing and finding comments to legal statutes.

### SUMMARY OF THE INVENTION

The “open law commentary” is a database of statutes and their subordinated sections and paragraphs, accessible online (through the world wide web), based on the ideas of open content and open access. The database consists not only of statutes but also of comments. Each comment refers to a section or paragraph of a particular statute and was entered by an internet user. Subsequent to a comment additional comments can be added. Everybody has the opportunity to be actively involved. Although its first addressees are lawyers, legal education is not necessary to use the commentary. The “open law commentary” is a place to publish professional opinions. Especially lawyers and those who are interested in the law can use this application as a new way of discussion and publication. The result is a reliable source of the law and its interpretation, ensured by critical review. The comments are reviewed by the user community. Comments can be modified, discussed and even deleted.

### DETAILED DESCRIPTION OF THE INVENTION

A software-supported application on an internet website provides for a compilation of legal statutes (database). The database including the comments is stored on a server. The statutes can be searched by index and keywords. A selected statute appears with headings in a tree structure. By selecting a particular provision, its text is displayed online. By selecting a link on the website, a text frame appears and the comment can be entered and saved. If other comments to a particular provision were already entered before, they also appear subsequent to the provision. By selecting a link which refers to the provision or the other comment or comments, a text frame appears and the comment can be entered and saved. For already existing comments a second link is provided. By clicking a text frame appears, including the already existing comment. The author can modify the text and save it. The modified comment is shown on the website as well as a protocol of the changed wording.

The main purpose of the “open law commentary” is to find the applicable meaning of “the law”, i.e. a certain statute. This depends on the literal sense, the correlation, the history of origin of the statute and its purpose. The literal sense is described by the grammatical interpretation, i.e. the crucial point is the legislator's objective will expressed in the statue's words. An explicit literal sense is binding, unless the purpose of the statute demands another interpretation. The interpretation according to the correlation means that a particular statute, section or paragraph has to be interpreted in correlation to the whole system of laws and statutes. Finally, also a statute's history of origin is an appropriate source for interpretation.

There are different ways of argumentation within the scope of legal interpretation. If a statute allows more than one interpretation, the author may interpret extensively, i.e. a broader range is covered by the statute, whereas another author may use an restrictive interpretation. By the way of legal analogies a statute covering a particular matter of facts is transferred to another matter of facts which is not directly covered yet. Conversely, it can also be shown that a legal analogy shall not be applied because a particular matter of facts is not covered by such statute. In the process of decision making by judges there might also emerge a legal gap. Where a matter of fact is not covered by law at all and the rules of interpretation are insufficient, the gap can be closed by applying a certain statute and by referring to its purpose in particular.

The reason for commenting statutes (including sections and paragraphs) is to discuss and explain their purpose, the requirements for their application and their legal consequences. By applying the principles and rules shown above the author structures and summarized his conclusions in a comment. Therefore the author is free to use other documents which are related to the particular statute (e.g. the reasoning for introducing the statute, protocols), but also decisions by the courts referring to that statute.

The structure of the law commentary consists of a selection of statutes. Each statute may be divided into sections and paragraphs. The core of the “open law commentary” is the single provision (e.g. UCC§ 2-313). The statutes can be viewed on the screen by use of a standard internet browser. The presentation and commenting happens by use of a standard software. Within a single comment, several aspects of a provision are subject to discussion. Several comments to the same provision can be put in chronological order. But the author is free to choose a position for his comment. If a comment to a provision is already existing, the author can not only enter an additional comment but also modify the existing. It is recommended to do so, when the existing comment has some fundamental or formal error or when there is a better wording for the expressed comment. If an author does not agree with the opinion in a comment, a modification is not appropriate. Instead a new comment should be given and posted right after the existing one, including an explanation for the dissent. For an open law commentary the respect for the full range of professional opinions is characteristic. However, it is also possible to take up a neutral position. Contradicting positions can be presented in any case, but arguments must be added which explain the author's opinion. The author shall neither understate nor overstate nor simply post the opposite view just for rhetorical reasons. If an author has personal emotional involvement in a topic, he shall refrain from commenting it to ensure the commentary's fair balance.

The author shall stick to the essence. The length of the comment shall be proportionally to its novelty, importance and the length of the other comments. The author shall keep the language of his comment neutral, i.e. the comment has to be factual and must not be tendentious.

The entered text has to meet professional standards. The actual state of jurisprudence and scholastic opinion must be considered and judgments and opinions by the author must be explained.

A special trait of law commentaries is citation. Cited statutes, cases, official actions, articles and textbooks support the author's comment. The rules of citation according to the jurisdiction the commented statute belongs to must be abided. To cite recent court ruling the author has to stick to the main statements and explanations and shall not cite the whole text of the reasoning.

The compliance with the specified rules is supervised by “administrators”. “Administrators” are users who voluntarily check the posted comments, structure them, enter subheadings and even delete the comments, if they are not consistent with the specified rules.

What claimed is:

1. A method to comment legal statutes in the internet and to publish those comments, comprising:
(a) Providing legal statutes including their sections and paragraphs in a database, which are made accessible through the internet (through the World Wide Web);
(b) Making viewable those statutes, sections and paragraphs, so that they can be retrieved by the internet user by the use of an internet browser;
(c) Input of text (comment) assigned to the particular sections by the internet user;
(d) Making viewable those text (comment), so that it can be retrieved by the internet user using an internet browser;
(e) Input of additional texts (comments) subsequent to already entered text (comments) by the internet user;
(f) Committing the meaning of the inputted text (comment) to the professional principles of legal interpretation according to the literal sense, to the history of origin, to purpose of the law, to the correlation, to the legal analogy, and committing the meaning of the inputted text (comment) to the rules of gap filling;
(g) Committing the meaning of the inputted text (comment) to the prevailing case law, jurisprudence and scholastic opinion;
(h) Structuring the inputted text (comment) by certain volunteer internet users (“administrators”);
(i) Erasing texts (comments), which were inputted against the commitments required under (f) by “administrators”.
(j) Erasing texts (comments), which were inputted against the commitments required under (g) by “administrators”.

2. A method of claim 1, wherein the inputted text (comment), which follows one or more comment or comments to a section of a statute, describes a totally or partly dissenting opinion to the proceeding comment or comments.
